(19) United States
(12) Patent Application Publication
(10) Pub. No.: US 2002/0041101 A1
(43) Pub. Date: Apr. 11, 2002

(54) Device for opening a security screen

(76) Inventor: Thomas Anthony Carey, Wetherill Park (AU)

Correspondence Address: OPUS MANAGEMENT PTY. LTD., P.O. BOX 6352, AUSTRALIA PARK, 2164, AU

(21) Appl. No.: 09/961,748

(22) Filed: Sep. 21, 2001

(30) Foreign Application Priority Data
Oct. 11, 2000 (AU) PR0687

(51) Int. Cl. E05C 19/00

(52) U.S. Cl. 292/1

(57) ABSTRACT

There is provided a device (10) for opening a security screen (12) locked by a latch member (130). The device (10) comprising telescopically extending members (14,16,18) having a striking member (40), the striking member (40) being contactable with the latch member (130) in use to release the latch member (130) when the telescopically extending members are in an extended position.

### TECHNICAL FIELD

The present invention relates to a device for opening a security screen.

### BACKGROUND OF THE INVENTION

The use of security screens made, for example, from aluminium mesh, is widespread and is a known and an accepted economical way to secure windows and the like from intruders. There are a number of methods for securing such conventional screens to a building. One way is to have a screen which is fixedly attached to the building, the screen being unopenable from either the outside or the inside of the building. These types of screens have the disadvantage that whilst they may act as an effective deterrent to intruders, they can pose a fire hazard as it is not possible to open them from the inside in the event of an emergency, thereby precluding the window to which the screen is attached from acting as an escape route.

It is known to have screens which are openable from, for example, the inside of the building to which they are attached. Such screens may include a keylock to secure the screen and also render it openable in the event of an emergency Such screens suffer the disadvantage that, should exit in an emergency be necessary, it may be difficult to open the screen as valuable time may be lost in locating the key, particularly if visibility is impaired for example due to smoke. Once found, in such circumstances it may also be difficult and time consuming to locate the key in the actual lock to unlock the screen.

To overcome the problems outlined above, some keyless systems have been developed in which a lock for locking the screen is located in a box adjacent the frame of the window over which the screen is attached, the lock being openable by depression of a member which unlocks the locking member. The problems with such systems are that it is generally possible for the box, and therefore the screen, to be opened from the outside by an intruder using either an implement such as a pen or coathanger, or a person having small enough hands to reach through an opening in the screen, open the box and deactivate the luck thereby enabling the screen to be opened and entry to the building. It is typical for such boxes to have an openable cover covering the locking mechanism which is usually held shut by means of VELCRO (RTM) or the like. One way of overcoming the aforementioned problems with such screens has been to modify the screen itself to include additional bars extending across the screen but this may considerably reduce the amount of daylight which can pass though the screen.

### OBJECT OF THE INVENTION

It is the aim of the present invention to substantially overcome or ameliorate at least one of the above disadvantages, or at least to provide a useful alternative.

### SUMMARY OF THE INVENTION

According to the present invention in a first aspect there is provided a device for opening a security screen locked by a latch member, the device comprising a telescopically extending member having a striking member, the striking member being contactable with the latch member in use to release the latch member when the telescopically extending member is in an extended position.

Preferably, the telescoping member is pivotable about a pivot member to move the telescoping member between a rest position and an operating position.

Preferably, the telescoping member comprises a first member and a second member, the second member being telescopically receivable in and retractable from the first member, the striking member being engagable with an engaging member connected to the first member in the extended position.

In a preferred embodiment the striking member is a threaded, and preferably comprises a rod, and the first and second members arc preferably tubular sections.

Preferably, the second member has an internal threaded section for threadably engaging the threaded striking member, the threaded striking member being extendable out of the second member on rotation of the first member relative to the second member.

### BRIEF DESCRIPTION OF THE DRAWINGS

A preferred form of the present invention will now be described by way of example with reference to the accompanying drawings wherein:

FIG. 1 is a schematic side elevation of the opening device in the extended position;

FIG. 2 is a cross-sectional plan view of the device of FIG. 1 for an inwardly opening screen which is in the locked position;

FIG. 3 is a perspective view of a portion of the device of FIGS. 1 and 2;

FIG. 4 is a cross-sectional plan view of the device of FIG. I for an inwardly opening screen which is in the unlocked position;

FIG. 5 is a cross-sectional plan view of the device of FIGS. 1 to 4 as viewed from the centre of the screen;

FIG. 6 is a cross-sectional plan view of the device of FIG. 1 for an outwardly opening screen which is in the locked position; and

FIG. 7 is a perspective view of an alternate embodiment of the opening device of FIG. 1 for an outwardly open screen.

### DETAILED DESCRIPTION OF THE PREFERRED EMBODIMENTS

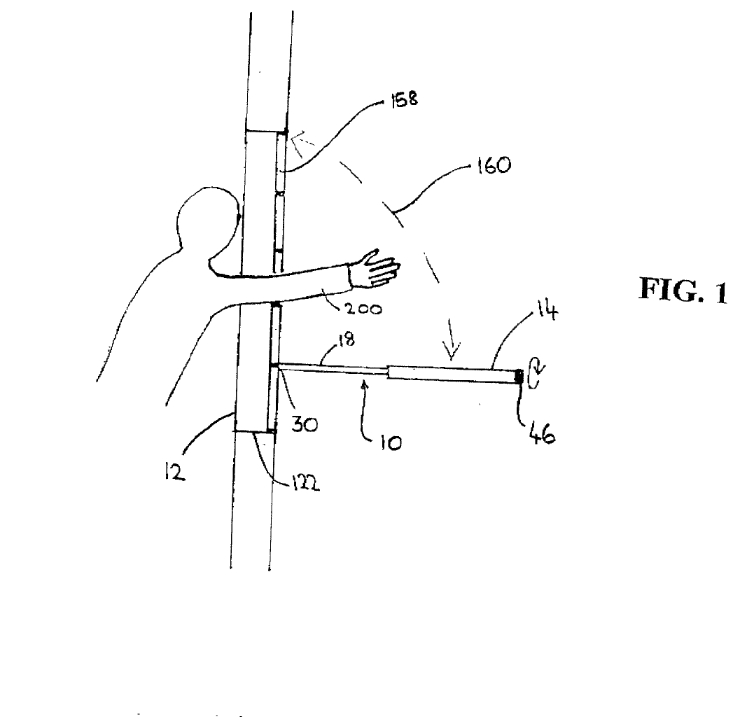

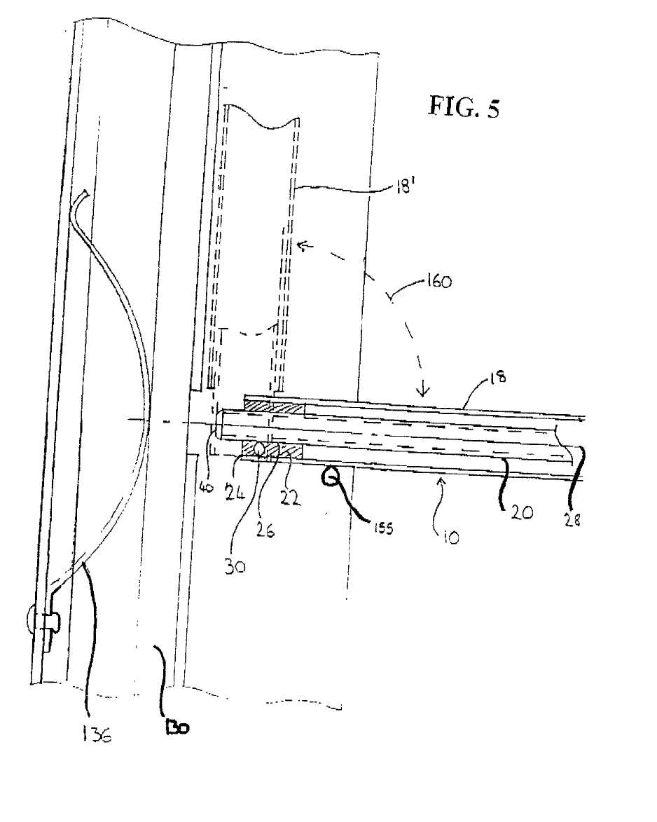

FIGS. 1 to 5 show an opening device 10 for opening a security screen 12 located on the inside of a building, extending over, for example, a window, the screen 12 being inwardly openable, The opening device 10 comprises a first outer tube 14, a second inner tube 16, a third tube 18 and an inner rod 20. The first and third tubes 14 and 18 have a square cross-section, and the second tube 16 and inner rod 20 have a circular cross-section. The inner rod 20 is threaded externally. The inner rod 20, and third and second tubes 18 and 16 are telescopically received within the first outer tube 14.

An internal block 22, which may be formed from nylon, is located adjacent a first flee end 24 of the third tube 18 and is wholly contained within the third tube 18. A threaded internal bore 26 extends tough the internal block 22 in a direction parallel to the longitudinal axis 28 of the third tube 18. The inner rod 20 extends through the third tube 18 and the headed outer portion of the inner rod 20 engages with the threads defining the internal bore 26 of the internal block 22, A pivot pin 30 extends through an aperture in the internal block 22 and correspondingly aligned apertures in the third tube 18. The pivot pin 30 is attached to a housing extrusion 32 containing the locking mechanism 34.

Attached to one end 36 of the inner rod 20 is a drive section 38 which has a square cross-section, The other end 40 of the inner rod 20 which is adjacent the internal block 22 acts as a contact member for depressing the locking mechanism 34, the operation of which is described in detail below.

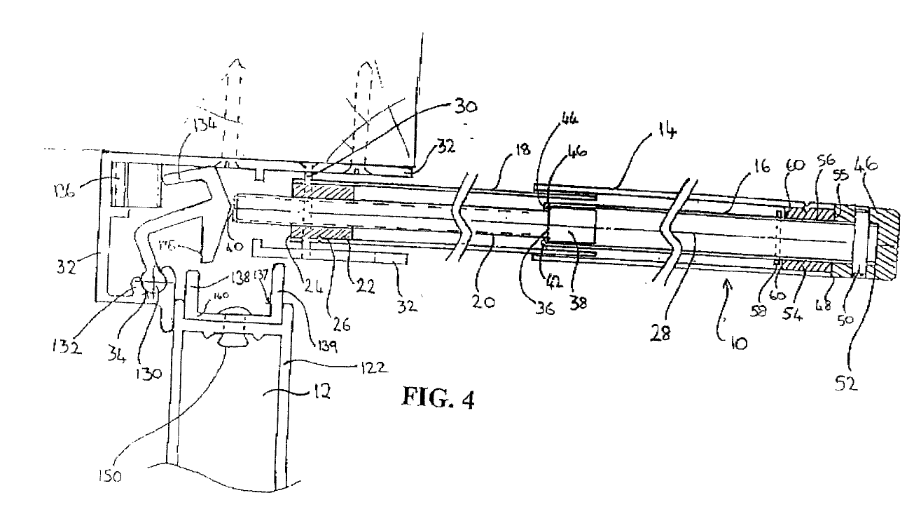

The second inner tube 16 is telescopically slidable with respect to the third tube 18 along die longitudinal axis 28 of the respective tubes, and inner rod 20, the inner rod 20 being telescopically receivable within the second tube 16 and the second tube being telescopically receivable within the third tube 18. The second tube 16 has a bevelled peripheral edge 42 at one free end 44 thereof. The bevelled edge 42 prevents the second tube 16 from being slidably removed from the inner rod 20 as the bevelled edge 42 contacts a flange portion 46 of the drive section 38 attached to one end 36 of the inner rod 20, preventing further longitudinal movement, As shown in FIG. 3, the free end 44 of the second tube 16 has a deformed square cross-section enabling it to engage with the drive section 38 attached to the inner rod 22.

The first outer tube 14 telescopically receives the third tube 18 and the inner rod 20. The second tube 16 is fixedly retained within the first outer tube 14. An end section 46 is attached to a free end 48 of the first outer tube 14. The end section 46 has a square cross-section. A pin 50 extends through correspondingly aligned apertures in the end section 46 and second tube 16 at a position adjacent the end 52 of the second tube 16 opposite to the end 46 of the second tube 16 which abuts the drive section 38 attached to the inner rod 20. The second tube 16 is thereby retained in position relative to the first tube 14. A bush 54 made from, for example nylon, is located adjacent the free end 48 of the first outer tube 14 and is wholly retained within the first tube 14. The second tube 16 extends through a longitudinally extending bore 56 which extends through the bush 54. A first end 55 of the bush 54 is flush with the end 48 of the first tube 14 and abuts the end section 46 attached to the first tube 14. A retaining clip 58 extends through correspondingly aligned apertures in the second tube 16 such that the retaining clip 58 is located adjacent the other end 60 of the bush 54.

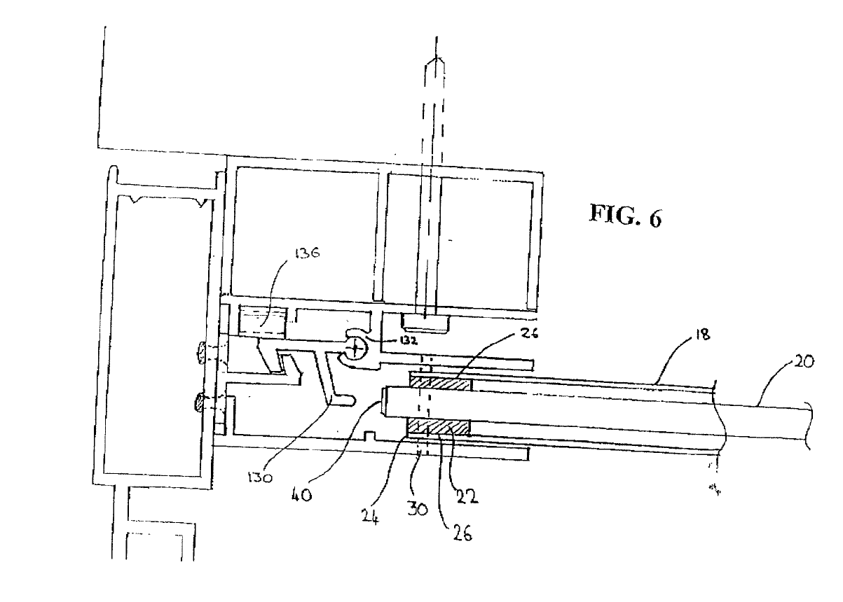

When not being used to unlock the locking element 130, the opening device 10 of the present invention may be stored in a cavity 158 located in an upright position extending adjacent or within the screen housing 122 of the security screen 12. The stored position of the third tube 18 is shown in phantom in FIG. 5 and denoted by reference numeral 18′. The opening device 10 is pivotable about the pivot pin 30 which extends through an aperture in the end section 22. In the position ready for use to unlock the locking member 130, as shown in FIG. 5, a rest pin 155 acts as a stop to prevent the locking device 10 from being pivoted beyond the desired position about pivot pin 30. The rest pin 155 abuts the outer surface of the third tube 18, as shown in FIG. 5 to prevent further rotation.

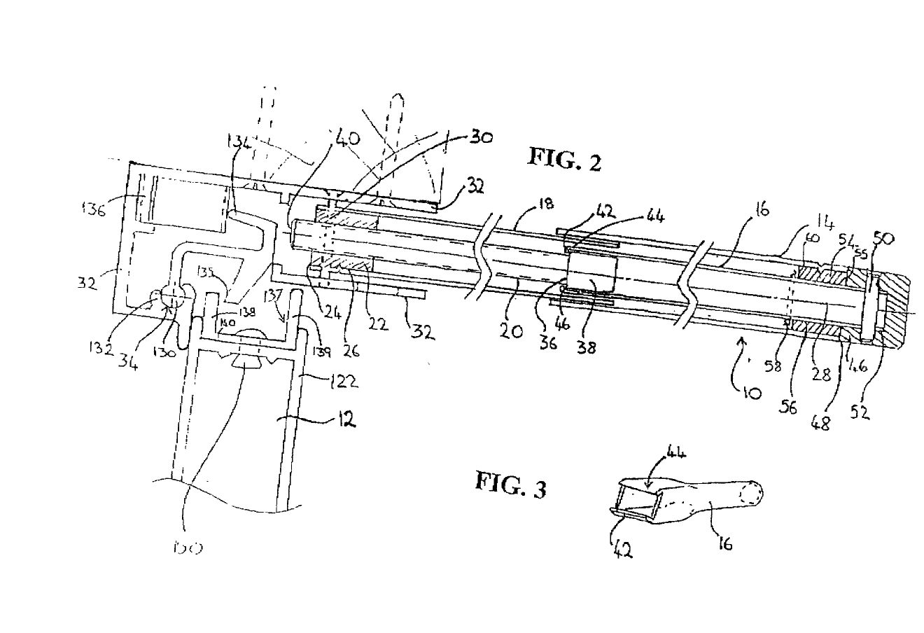

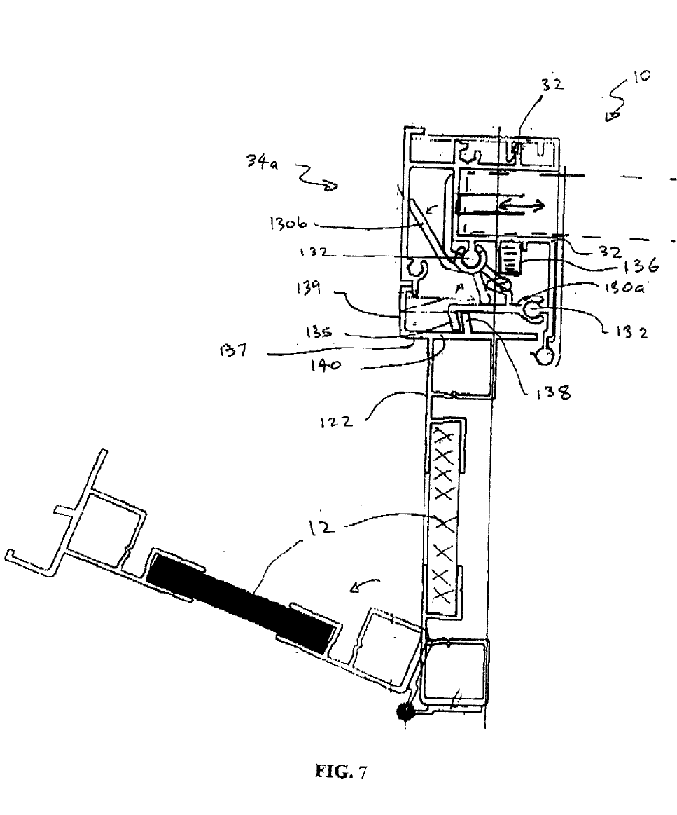

The opening device 10 of the present invention is suitable to unlock a conventional locking device 34 depicted in connection with the opening device 10 of the present invention in FIGS. 2 to 5 for inwardly opening security screens and similar type devices 34a in FIGS. 6 mid 7 for an outwardly opening security screen. The locking device 34 comprises a locking element 130, typically an aluminium extrusion, which is rotatably located and retained within a receiving member 132 attached to the housing extrusion 32. In FIG. 7, two parts 130a, 130b comprise the locking element both of which are pivotable about separate members 132 located on the housing extrusion 32. In FIGS. 1 to 7 a portion of the locking element 130 contacts a compression spring member 136 also located with the housing extrusion 32. A generally U-shaped member 137 has two arm portions 138 and 139 and a base section 140. The first arm portion 138 is shorter in length than the second arm portion 139 which acts as a barrier to external implements such as a jemmy which could be used by an intruder seeking to unlock the locking member 34 to open the security screen 12.

The U-shaped member 137 is attached to an edge portion of the screen housing 122 by means of a rivet, for example a pop rivet 150 or could be integrally formed as in FIG. 7. The expanded metal mesh screen 12 is fixed to the screen housing 122.

The screen housing 122 is held in the locked position as shown in FIG. 2 and 7 by an abutment member 135 which is part of the locking clement 130 which abuts the first arm portion 138 of the U-shaped member 137. In this locked configuration, the compression spring 136 is in its rest position. As seen in FIGS. 1 to 7 the spring 136 forces the locking element into abutment against the first arm portion 138.

To open the locking member 130 and thereby unlock the screen 12 using the opening device 10 according to the present invention, the procedure is as follows. The locking device 10 is pivoted about pivot pin 30 to remove the device 10 from its upright storage position within a cavity 158 in or adjacent to the screen housing 122. The opening device 10 is moved in an arcuate path 160 about the pivot pin 30 as shown in FIGS. 1 and 5 until the first, second and third tubes 14, 16, 18 and inner rod 20 lie in a plane substantially perpendicular to the plane of the screen 12. Further pivotal movement beyond this position about pivot point 30 is inhibited by the contact of the third tube 18 against the rest pin 15, as shown in FIG. 5.

The operator extends the opening device 10 by telescopically extending the first outer tube 14, and thereby the second tube 16 attached thereto, relative to the third tab 18. In the fully extended position, in which the length of the device 10 could be, for example, one meter in length, the bevelled edge 42 of the second tube 16 contacts the flange portion 46 of the drive section 38 attached to one end 36 of the inner rod 20 preventing further longitudinal extension. Once the device 10 is fully extended, the operator turns the first tube 14 in a clockwise direction. This motion has the effect of rotating the inner rod 20 as rotation of the first tube 14 causes rotation of the second tube 16 attached thereto and the end 44 of the second tube 16 engages the drive section 38 attached to the inner rod 20 causing rotation of the inner rod 20. This rotation of the inner rod 20 can only occur when the device is in the extended position with the end 44 of the second rod 16 engaging the drive section 38. The rotation of the inner rod 20, which is threadably engaged with the threads defining the aperture 26 in the internal block 22, allows the threaded inner rod 20 to extend outwardly of the third tube 18. The end contact surface 40 of the inner rod 20 contacts the locking element 130 causing it to depress the compression spring 136 and thereby rotate about the receiving member 132. This rotation of the locking element 130 frees the locking portion 135 from abutment against the first arm portion 138 disengaging the locking mechanism from the screen housing 122 allowing the screen to be opened.

After use, the device 10 may be retracted and pivoted about pivot pin 30 to be stored in the cavity 158. The cavity 158 preferably is 30 mm to 35 mm wide/deep.

FIGS. 6 and 7 show the device 10 for use in the opening of an outwardly opening security screen and the same reference numerals have been used to denote like elements as used with the inwardly opening screen shown in FIGS. 1 to 5. The same method as described above with respect to the inwardly opening screen 12 applies, the only difference for FIG. 6 being the shape of the locking member 130. The difference for FIG. 7 being that locking member 130 is comprised of two parts 130a and 130b both of which pivot about separate members 132 located on the housing extrusion 32.

It will be seen that the device 10 of the present invention has a number of advantages. Firstly, to operate the opening device 10 it is necessary to have the device 10 in the extended position which, as shown in FIG. 1, is beyond the reach of an intruder 200 rendering it virtually tamperproof from the outside. The present invention also allows a quick keyless opening of the security screen 12 from, for example, the inside and enables exit though the window opening in the case of an emergency. It may be possible to open the device 10 in approximately 5 seconds. Also, the dimensions of the opening device 10 are such that minimal intrusion into the space surrounding the window occurs. The device 10 and method of opening the security screen 12 can be installed and applied to existing security screens with minimal alteration necessary to the existing screen. In such cases, no alteration to the height of the screen need be made, merely the width of the screen could be reduced by, for example 35 mm to house the locking device 10 in a cavity 155 in the stored position. The security screen 12 may be easily opened using the device 10 for the purposes of cleaning and maintenance of the window and/or screen 12. The device 10 is economical having low maintenance and installation costs. Also, the device 100 may be manufactured to fit any height of opening such as a window or door to which a security screen 12 is to be attached, for example from a 600 mm wide/high opening to an 8 meter wide/high opening. Also, the location of operation of the device 10 may be arranged at any suitable and desired height The device 10 is easy to operate and operating instructions may be printed on a visible face thereof.

Various modifications will be evident to the person skilled in the art. For example, whilst the device 10 has been described with reference to a security screen for windows, the device could be equally applicable to such screens located adjacent doors or other openings. Also, the dimensions given are merely preferred examples and could vary. Preferred construction materials for the device 10 are aluminium extrusions, stainless steel, plastics material and spring steel.

The claims defining the invention are as follows:

1. A device for opening a security screen locked by a latch member, the device comprising a telescopically extending member having a striking member, the striking member being contactable with the latch member in use to release the latch member when the telescopically extending member is in an extended position.

2. The device of claim 1 wherein the telescopically extending member is pivotable about a pivot member to move the telescopically extending member between a rest position and an operating position.

3. The device of claim 1 or claim 2, wherein the telescopically extending member comprises a first member and a second member, the second member being telescopically receivable in and retractable from the first member, the striking member being engageable with an engaging member connected to the first member in the extended position.

4. The device of claim 3, wherein the striking member is a threaded rod.

5. The device of claim 3, wherein the first and second members are tubular sections.

6. The device of claim 4, wherein the second member has an internal threaded section for threadably engaging the threaded striking member, the threaded striking member being extendable out of the second member on rotation of the first member relative to the second member.

7. A device for opening a security screen locked by a latch member, said device substantially as herein described with reference to any one of the embodiments of the invention shown in the accompanying drawings.
